(19) United States
(12) Patent Application Publication
(10) Pub. No.: US 2010/0215202 A1
(43) Pub. Date: Aug. 26, 2010

(54) Modular Loudspeaker Device Installable In Computer Drive Bay

(76) Inventor: Ke-Wei CHIN, Taipei (TW)

Correspondence Address: Jackson Intellectual Property Group PLLC, 106 Starvale Lane, Shipman, VA, 22971, US

(21) Appl. No.: 12/193,839

(22) Filed: Aug. 19, 2008

(51) Int. Cl. H04R 1/02

(52) U.S. Cl. 381/386

(57) ABSTRACT

A modular loudspeaker device installable in a computer drive bay is provided, which turns a multimedia loudspeaker into a standardized device. The modular loudspeaker device, which matches a 5.25-inch drive bay of a case of a personal computer, can be disposed and secured in the 5.25-inch drive bay and connected with power and audio signals, so as to serve as a multimedia audio output device of the personal computer.

### BACKGROUND OF THE INVENTION

1. Technical Field

The present invention relates to a modular loudspeaker device installable in a computer drive bay, thereby turning a multimedia loudspeaker into a standardized device. More particularly, the modular loudspeaker device matches a 5.25-inch drive bay of a case of a personal computer and can be disposed and secured in the 5.25-inch drive bay so as to serve as a multimedia audio output device of the personal computer.

2. Description of the Related Art

With the booming development of multimedia information, personal computers or other information equipment are generally furnished with audio/ video devices such as CD players or DVD players for playing back audio/video contents. The rapid advancement of Internet technologies further allows audio/video contents to be downloaded and played back directly via the Internet, thereby providing more convenient audio/video functions.

Nowadays, there are numerous kinds of multimedia loudspeakers in the market of personal computer peripherals. However, conventional multimedia loudspeakers are generally external devices and require resonance chambers for generating adequate audio effects. Therefore, most of the conventional multimedia loudspeakers are bulky and take up a lot of room or table space.

There were once loudspeakers installable in the standard 5.25-inch drive bays of computer cases. But one major drawback of such loudspeakers is that the 5.25-inch computer drive bay, which is only 42 mm high, cannot provide an effective reverberant space. Consequently, with poor audio effects and small acoustic volume that fail to meet the multimedia audio requirements of new-generation computers, those loudspeakers were rejected by consumers and eventually dropped out of the market.

### BRIEF SUMMARY OF THE INVENTION

The present invention provides a multimedia loudspeaker device with a modular structure complete with a resonance chamber. An amplifier circuit of the loudspeaker device is driven directly by a power supply of a personal computer, so as to amplify vibrations of loudspeaker drivers in the loudspeaker device. The loudspeaker device is further provided with a specially designed spiral or cylindrical acoustic path for enhancing audio effects and making them comparable with those produced by externally connected large loudspeakers.

The loudspeaker device according to the present invention can be fitted into a 5.25-inch drive bay of a computer case and therefore saves a lot of space. Since external loudspeakers are no more needed, the present invention also significantly increases the convenience of personal computers. In addition, according to the present invention, acoustic waves generated by the loudspeaker drivers can resonate and reverberate in the spiral or cylindrical reverberant space so as to produce good audio output.

The modular loudspeaker device installable in a computer drive bay according to the present invention can be secured by screws in a 5.25-inch drive bay of a case of a personal computer, is provided therein with loudspeaker drivers and an amplifier circuit, and can be connected with a DC power supply and a signal source of the computer, thereby converting signals transmitted from an audio player coupled with the modular loudspeaker device into vibrations of the loudspeaker drivers.

The modular loudspeaker device has a casing that houses one or two loudspeaker drivers, which can output either individually or simultaneously through left and right sound channels, respectively. The “spiral” or “cylindrical” reverberant space disposed behind the one or two loudspeaker drivers for allowing resonance and reverberation produces an echo effect, such that vibrations of the one or two loudspeaker drivers are transformed into good audio output. The spiral or cylindrical reverberant space guides acoustic waves to converge toward and accumulate in the tail end of the reverberant space, thereby prolonging resonance and generating an audio effect better than that produced in a simple hexahedron space.

### BRIEF DESCRIPTION OF THE SEVERAL VIEWS OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a modular loudspeaker device installable in a computer drive bay according to the present invention;

FIG. 2 provides a front view and a top view of the modular loudspeaker device installable in a computer drive bay according to the present invention;

FIG. 3 provides a front view and a top view of another embodiment of the modular loudspeaker device installable in a computer drive bay according to the present invention;

FIG. 4 is a schematic drawing showing the modular loudspeaker device according to the present invention being put into a 5.25-inch drive bay of a computer case; and

FIG. 5 is a schematic drawing showing the modular loudspeaker device according to the present invention installed in a 5.25-inch drive bay of a computer case.

### DETAILED DESCRIPTION OF THE INVENTION

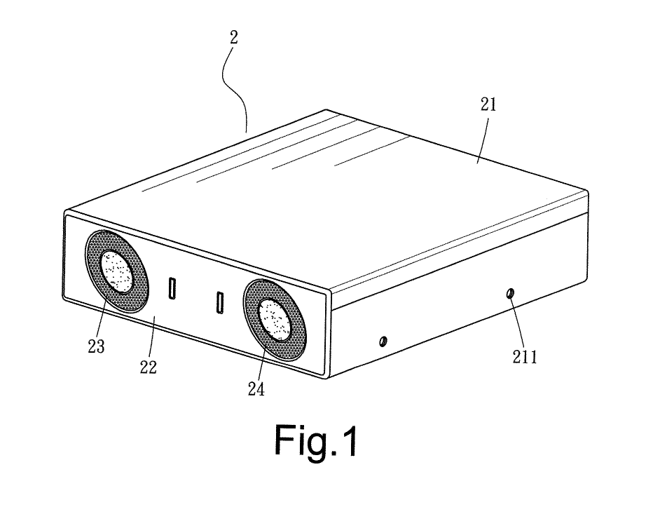

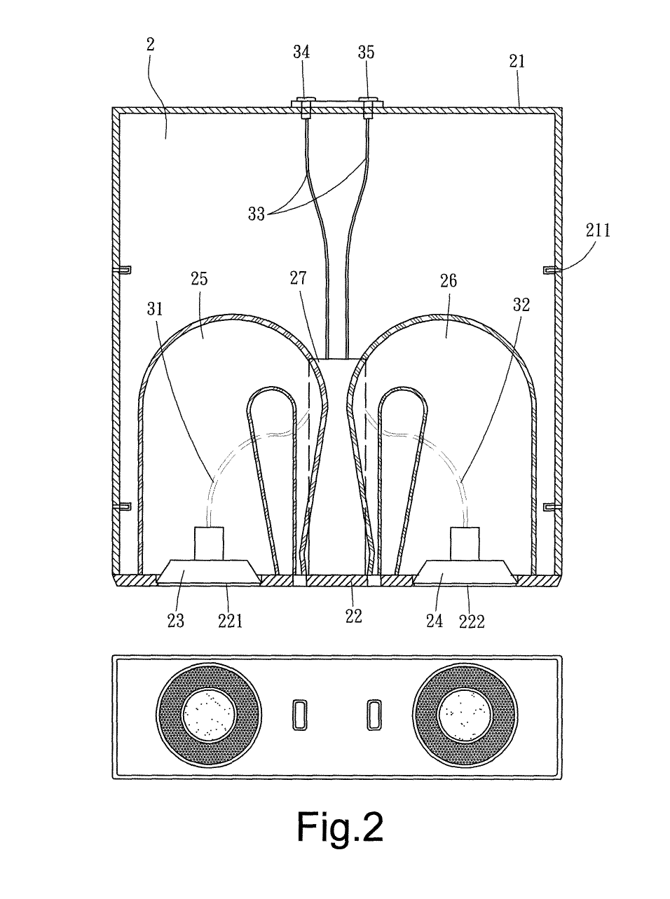

Referring to FIGS. 1 and 2, a modular loudspeaker device installable in a computer drive bay according to the present invention comprises a 5.25-inch loudspeaker carrier 2 having a width and a height corresponding to a width and a height of a 5.25-inch drive bay 11 of a case of a computer 1. The 5.25-inch loudspeaker carrier 2 includes a casing 21, a panel 22, one or two loudspeaker drivers 23 and 24, spiral reverberant bodies 25 and 26, an audio amplifier circuit board 27, a power input terminal 34 and an audio signal connection terminal 35.

The panel 22 of the 5.25-inch loudspeaker carrier 2 is formed with through holes 221 and 222 for securing the loudspeaker drivers 23 and 24 therein, so that the loudspeaker drivers 23 and 24 are adjacent to outside. The spiral reverberant bodies 25 and 26 are fixedly provided behind the loudspeaker drivers 23 and 24 in the 5.25-inch loudspeaker carrier 2 for transforming acoustic waves generated by the loudspeaker drivers 23 and 24 into good audio output. The audio amplifier circuit board 27 in the 5.25-inch loudspeaker carrier 2 is provided with an amplifier circuit and electronic components. The loudspeaker drivers 23 and 24 are electrically connected by electric wires 31 and 32 to the audio amplifier circuit board 27, which in turn is electrically connected by electric wire 33 to the power input terminal 34 and the audio signal connection terminal 35 fixedly provided on the casing 21 of the 5.25-inch loudspeaker carrier 2. The power input terminal 34 can be connected with an output terminal of a power supply for receiving DC power. The audio signal connection terminal 35 can be connected with an audio output terminal on a motherboard of the computer 1 for receiving audio signals.

The casing 21 of the 5.25-inch loudspeaker carrier 2 is bilaterally provided with threaded seats 211 corresponding in position to threaded fastening holes on the 5.25-inch drive bay 11 of the case of the computer 1, so that the 5.25-inch loudspeaker carrier 2 can be secured in the 5.25-inch drive bay 11 of the case of the computer 1 with screws.

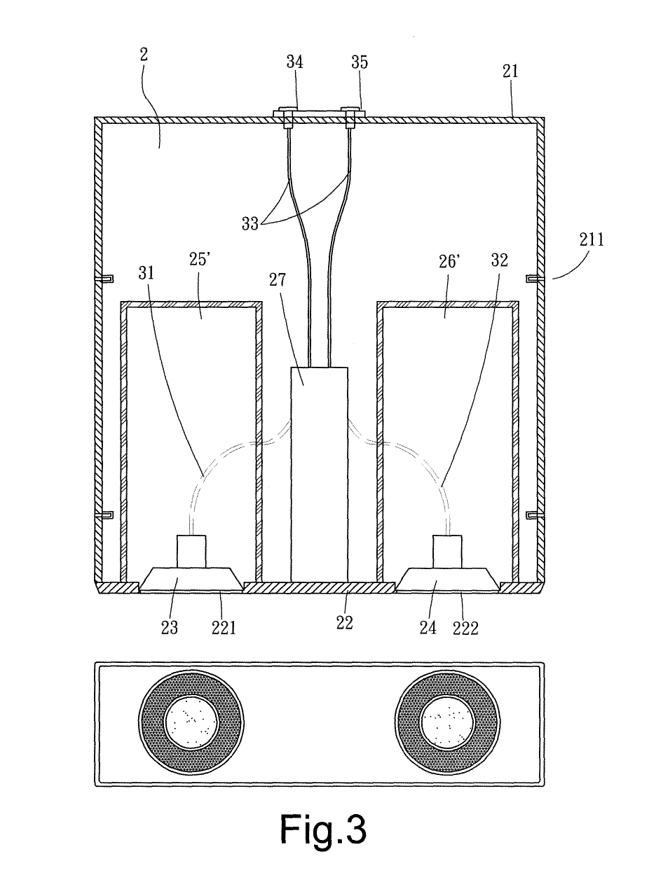

Referring to FIG. 3, the spiral reverberant bodies 25 and 26 which are located behind the loudspeaker drivers 23 and 24 in the 5.25-inch loudspeaker carrier 2 may also be implemented in the form of cylindrical reverberant bodies 25′ and 26′, which are also capable of transforming the acoustic waves generated by the loudspeaker drivers 23 and 24 into good audio output.

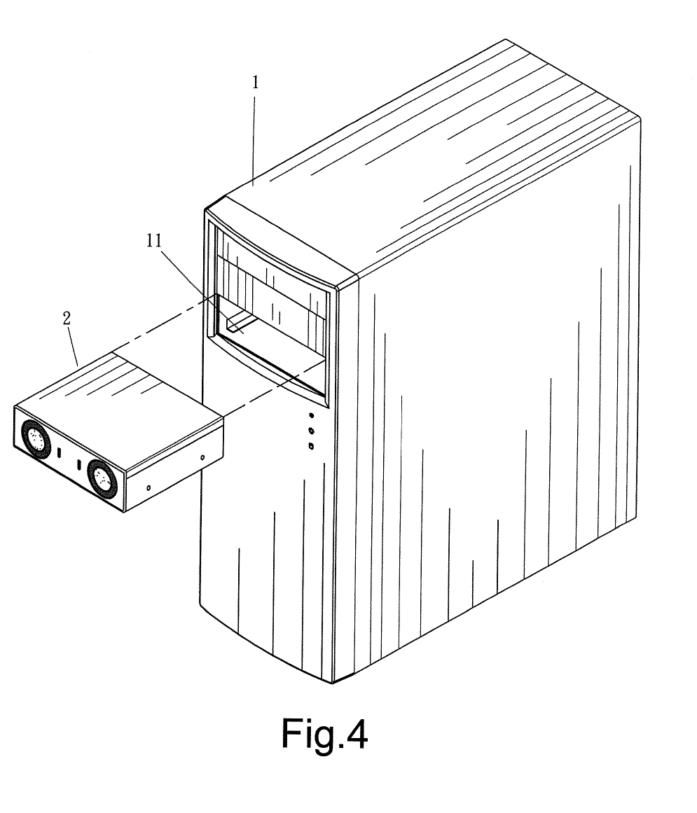

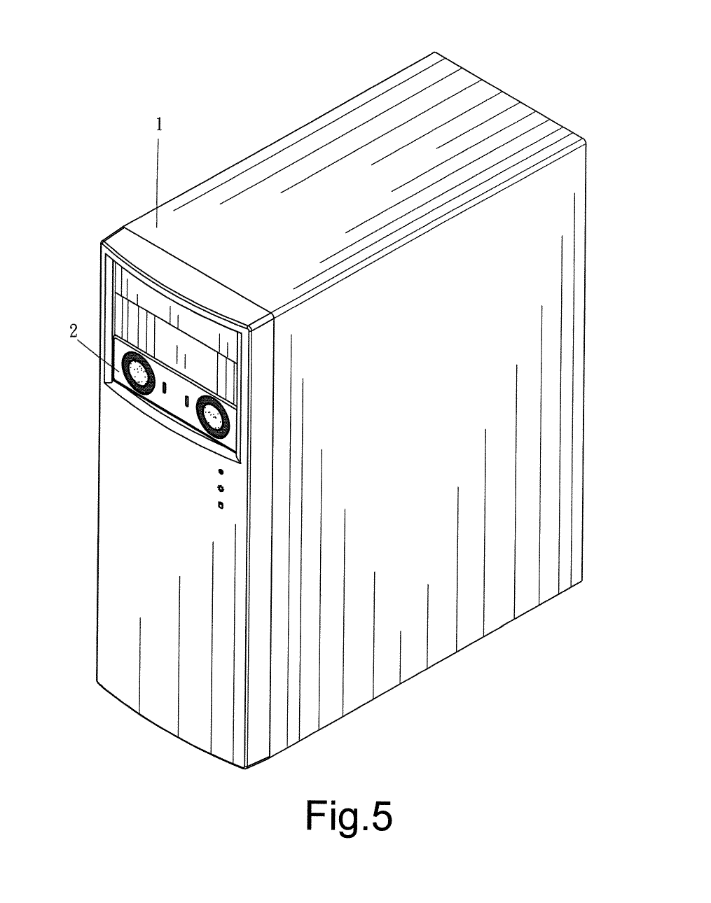

FIGS. 4 and 5 are schematic drawings showing the 5.25-inch loudspeaker carrier 2 of the modular loudspeaker device according to the present invention being and having been installed in the 5.25-inch drive bay 11 of the case of the computer 1, respectively. Hence, the present invention can save considerable space and make external loudspeakers no more necessary, thereby improving the convenience of personal computers. Besides, according to the present invention, acoustic waves generated by the loudspeaker devices can resonate and reverberate in the spiral or cylindrical reverberant space so as to produce good audio output.

1. A modular loudspeaker device installable in a computer drive bay, comprising a 5. 25-inch loudspeaker carrier having a width and a height corresponding to the width and a height of a 5.25-inch drive bay of a case of a computer so as to be received in the 5.25-inch drive bay, the 5.25-inch loudspeaker carrier comprising a casing, a panel, one or two loudspeaker drivers, one or two spiral reverberant bodies, an audio amplifier circuit board, a power input terminal and an audio signal connection terminal.

2. The modular loudspeaker device of claim 1, wherein the panel of the 2.25-inch loudspeaker carrier is formed with one or two through holes for securing the one or two loudspeaker drivers therein, so that the one or two loudspeaker drivers are adjacent to outside.

3. The modular loudspeaker device of claim 1, wherein the one or two spiral reverberant bodies are located behind the one or two loudspeaker drivers for transforming acoustic waves generated by the one or two loudspeaker drivers into good audio output.

4. The modular loudspeaker device of claim 1, wherein the one or two loudspeaker drivers are electrically connected by electrical wires to the audio amplifier circuit board, and the audio amplifier circuit board is electrically connected by electrical wires to the power input terminal and the audio signal connection terminal fixedly provided on the casing of the 5.25-inch loudspeaker carrier for receiving necessary power and audio signals.

5. The modular loudspeaker device of claim 1, wherein the casing of the 5.25-inch loudspeaker carrier is bilaterally provided with threaded seats corresponding in position to threaded fastening holes on the 5.25-inch drive bay of the case of the computer for securing the 5.25-inch loudspeaker carrier in the 5.25-inch drive bay of the case of the computer with screws.

6. The modular loudspeaker device of claim 1, wherein the one or two spiral reverberant bodies located behind the one or two loudspeaker drivers in the 5.25-inch loudspeaker carrier are implemented in the form of one or two cylindrical reverberant bodies.
